(19) United States
(12) Patent Application Publication
(10) Pub. No.: US 2010/0162906 A1
(43) Pub. Date: Jul. 1, 2010

(54) FOOD PEELER

(76) Inventor: Thomas John Scimone, Campbell, CA (US)

Correspondence Address: John Nielsen;RANDICK O'DEA & TOOLIATOS, LLP, 5000 HOPYARD ROAD, SUITE 400, PLEASANTON, CA, 94588, US

(21) Appl. No.: 12/345,207

(22) Filed: Dec. 29, 2008

(51) Int. Cl. A23N 7/00; B25G 3/00; B26B 3/00

(52) U.S. Cl. 99/541; 30/345; 30/278

(57) ABSTRACT

Disclosed is a food peeler comprising a conical shaped handle having a longitudinal axis, a head containing a blade holder affixed to the top of the handle, the head having an axis transverse to the axis of the handle, the head comprising an elongated member with a recessed inner section, defining opposed vertically situated walls on opposite sides of the recessed inner section. The walls have flat inner surfaces, and vertically oriented projections extending from the surfaces thereof, and an orifice in the upper section of each wall, a blade mounted within a blade holder positioned within the recessed inner section, the blade comprising a flat elongated member having one exposed sharp edge, the blade holder further having a pin at each end thereof, each pin adapted to fit within one of the orifices of the walls to secure the blade holder in place.

### BACKGROUND OF THE INVENTION

A. Field of Invention

This invention relates to a food peeler which is useful in the kitchen to peel fruits such as apples, and vegetables such as potatoes, cucumbers, and the like. More particularly, it relates to a fruit and vegetable peeler that has a blade mounted transversely to the handle, and which provides efficient removal of the skin and outer layers of common fruits and vegetables.

B. Description of Related Art

There are many fruit and vegetable peelers presently sold in the United States. Many of such peelers are patented. See, for example, U.S. Pat. Nos. 7,415,769; 7,077,058; 6,874,236; 6,854,383; 6,671,965; 6,327,971; 6,125,744; 5, 865,110; and 5,845,565, to name a few.

A common problem with food peelers in general is that they tend to clog up with portions of the peels that are removed by the blades of the peelers. This is an undesirable situation, as it requires frequent cleaning of the blade and peeler, and is frustrating to the user of the peeler, as it impairs efficient use of it.

### SUMMARY OF THE INVENTION

The present invention relates to a food peeler that has a handle, and a head mounted transverse to the handle containing a blade holder. The blade holder containing a fixed blade is rotatable around an axis that is transverse to the axis of the handle. Because the blade holder, and thus the blade, is rotatable, it enables the user to keep the pathway clear for removed peel portions to exit the peeler, thereby enabling the peeling process to be more efficient. The rotatable blade holder provides great flexibility for the peeler to be used with a wide variety of fruits and vegetables whose skin surface may vary widely in thickness and texture.

It is an object of this invention to provide an improved food peeler that has a rotatable blade holder containing a blade mounted thereon that allows peeled material to exit from the peeler in an efficient manner.

It is a further object of the invention to provide an improved fruit and vegetable peeler that is efficient in removing skin surfaces from fruits and vegetables, and other objects.

These and other objects will be apparent from the description to follow.

### BRIEF DESCRIPTION OF THE DRAWINGS

FIG. 1 is a top view of the food peeler of the invention.

FIG. 2 is a side view of the food peeler of the invention.

FIG. 3 is a bottom view of the food peeler of the invention.

FIG. 4 is a cross sectional view along the line 4-4 of FIG. 1.

FIG. 5A is a perspective view of the head of food peeler of the invention showing the blade mechanism in place.

FIG. 5B is a perspective view of the head of the peeler showing the blade mechanism removed from the head.

### DESCRIPTION OF THE PREFERRED EMBODIMENT

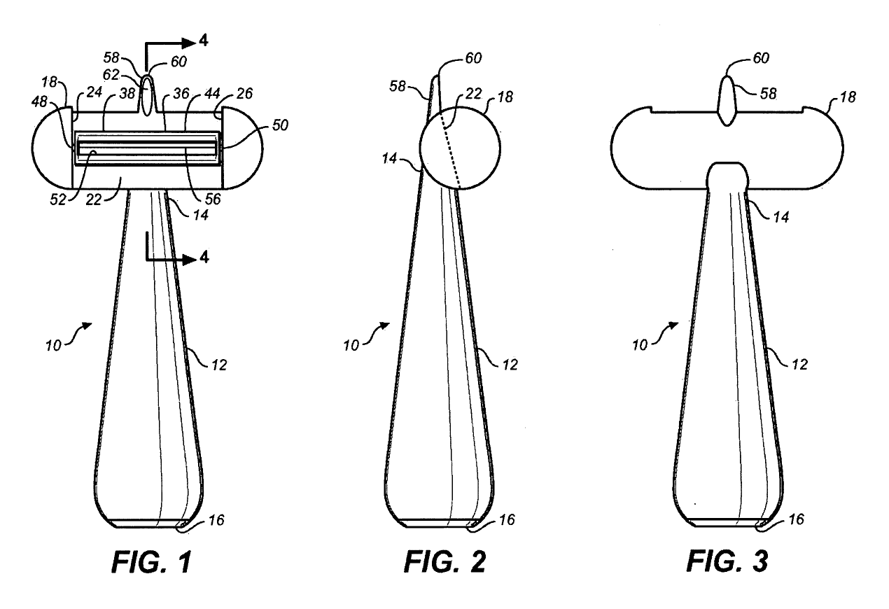

The food peeler 10 of this invention is shown in FIGS. 1-4, 5A and 5B. As seen best in FIG. 1, the peeler 10 comprises a round, conically shaped, tapered handle 12 that has a longitudinal axis, and opposed top and bottom ends 14, and 16.

The conically shaped handle 12 tapers inward from the bottom end 16 to the top end 14. Thus, the diameter of the handle 12 at the bottom end 16 is substantial larger than the diameter at the top end 14. In the preferred embodiment, the diameter of the handle 12 at the bottom end 16 is about one and one-eighth inches, while the diameter of the handle 12 at the top is about three-eighths inches.

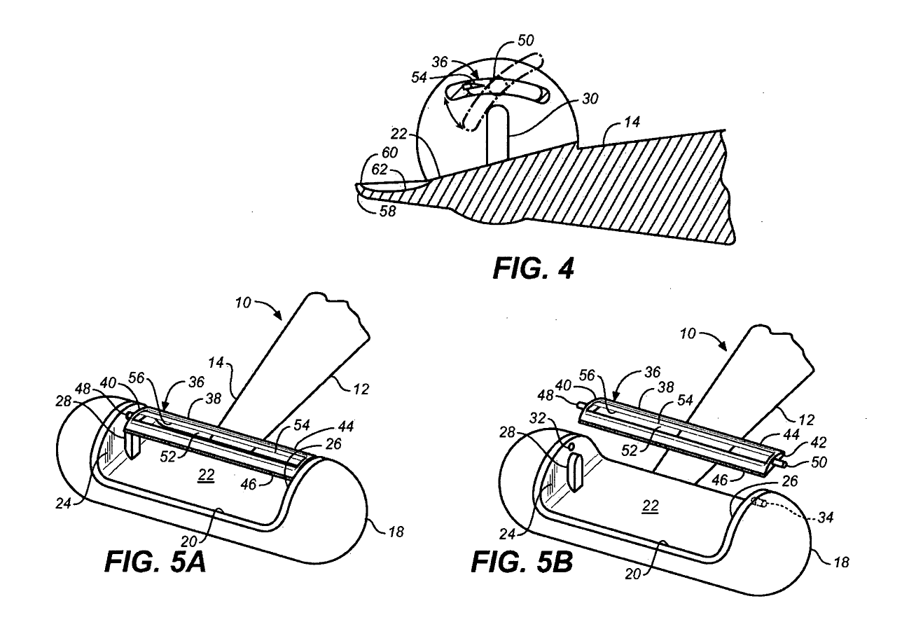

An elongated head 18 is mounted on the top end 14 of the handle 12. The elongated head 18 has an axis that is transverse to the axis of the handle 12. The head 18 is generally cylindrical in configuration, and has a U-shaped recess 20 in the middle portion thereof. As seen best in FIG. 5B, the recess 20 defines an area with a flat base surface 22, and flat opposed vertical walls, 24 and 26. As seen best in FIGS. 2 and 4, the base surface 22 is sloped, so that it appears to be a continuation of the top edge of the handle 12 when the handle 12 is in resting position on a flat surface.

Vertical projections or stops 28, 30, extend inward from the flat vertical walls 24, and 26, respectfully, into the space of the recess 20. The projections 24 and 26 serve as a stop for the blade holder described below.

As seen in FIG. 5B, the flat vertical walls 24 and 26 each have holes 32, and 34 in the upper portions thereof whose purpose will be described below.

A blade holder 36 is positioned horizontally within the recess 20 of the head 18. The blade holder 36 comprises an elongated rectangular frame 38 having opposing ends 40, 42 and opposed sides 44 and 46. The blade holder 36 has a pin 48 and 50 extending outward from each end 40 and 42. To secure the blade holder 36 to the head 18, the pins 48 and 50 are inserted into the holes 32 and 34 in the walls 24 and 26 defined by the recess 20 in the head 18. As seen best in FIGS. 4, 5A, and 5B, the ends 40 and 42 of the blade holder 36 are angled upward to form an arch, with the pins 48, 50 extending from the ends 40 and 42 at the height of the arch in the middle of the holder 36. The opposed sides 44 and 46, and opposed ends 40 and 42 of the blade holder 36 define an open space 52 in the middle thereof. A thin, elongated, rectangular blade 54 having a sharp cutting edge 56 is fixed in position on the farthest side 44 of the holder 36, and projects inwardly into the open space 52. That is, the sharp cutting edge 56 of the blade 54 projects into the open space 52. When the blade 54 is urged against a surface of a fruit or vegetable, the blade 54 cuts the surface thus peeling off a portion of the fruit, which passes through the open space 52 between the sharp cutting edge 56 of the blade, and the inner edge of the side 46 of the blade holder 36. The blade 54 can be metal or ceramic. It is preferred that the blade be ceramic as it will last longer, and not rust.

The blade holder 36, and thus the blade 54, is rotatable around the axis of the pins 48 and 50 extending from each side thereof. The extent of rotation is limited by the projections or stops 28 and 30 extending from the vertical walls 24, and 26. When an individual desires to peel a fruit or vegetable, the handle 12 is grasped with the hand, and the blade 54 is placed in contact with the surface of the fruit or vegetable. The peeler 10 is then urged toward the user. The blade 54 engages the surface of the fruit or vegetable, and the blade holder 36 moves the blade 54 around its axis, until movement is restricted as the holder 36 abuts the projections 28, 30 on each side.

In a preferred embodiment of the invention, as seen in FIGS. 1, 3 and 4, the handle 12 has an extension 58 at the top thereof which is called an eyer. The eyer 58 has a sharp point 60 and a scooped out surface 62, forming a bowl. The purpose of the eyer 58 is to enable the user to remove specific areas of rot from fruits or vegetables either before, during or after the peeling process.

The eyer 58 is an optional feature of the food peeler 10 of this invention.

In the most preferred embodiment of the invention, the handle 12 is about four and one quarter inches long from the top end 14 to bottom end 16. It is one and one eighth inches in diameter at the bottom end 16, and three eighths inches in diameter at the top 14.

The head 18 is about two and three fourths inches in length, and the width of the recess 20 is two inches, while the depth is three eighths inches. The blade holder 36 is two inches in width, and the blade 54 is one and five-eighth inches in width.

It will be recognized by those skilled in the art that various modifications can be made in the peeler described herein without departing from the scope and spirit of the invention.

I claim:

1. A food peeler comprising:
(a) a handle;
(b) a head connected transversely to said handle, said head having a recess therein; and
(c) a blade pivotably mounted in said recess.

2. A food peeler comprising:
(a) a handle having a longitudinal axis, said handle being generally conical in shape and circular in cross section, said head having a lower end, and an upper end, the diameter of the handle being gradually reduced from the lower end to the upper end;
(b) a head affixed to the top of said handle, said head having an axis transverse to the axis of said handle, said head comprising an elongated member with a recessed section in the middle thereof defining opposed vertically situated ears on opposite sides of said recessed inner section, said ears having flat inner surfaces, vertically oriented projections extending from the surfaces thereof, and at least one orifice in the upper section of each ear;
(c) a blade holder positioned within said recessed inner section, said blade holder having an open inner area, said blade holder further having a pin at each end thereof, each pin being adapted to fit into the orifice in said flat inner surface of said ear; and
(d) a blade positioned within said blade holder, said blade comprising a flat surface having a sharp edge facing said open inner section, whereby, when a food item is being peeled, said blade is effective to peel the skin off of a food item, said blade holder being moveable within said head in a rotational manner around the axis of said orifices, and limited in rotation by said vertically oriented projections.

3. The food peeler of claim 2 which further has an eyer projecting form the top thereof.

4. The food peeler of claim 2 wherein the diameter of said handle at the bottom thereof is about twice the diameter at the top.

5. The food peeler of claim 2 wherein said recess defines a flat base surface and opposed flat side surfaces.

6. The food peeler of claim 2 wherein said blade holder is substantially rectangular in shape, has opposing sides, and opposing ends, which define an open inner space, said ends being arched, a pin projecting outwardly from the ends of said holder.

7. The food peeler of claim 6 wherein said blade holder has a blade secured therein having a sharp cutting edge, and wherein the sharp cutting edge of said blade extends into said open space.

8. The food peeler of claim 6 wherein said blade is rectangular in configuration, and is made of a ceramic material.

9. The food peeler of claim 2 wherein said head is of cylindrical configuration.

10. The food peeler of claim 2 wherein the flat base surface of said recess is a continuation of the same plane as the upper edge of said handle when it lays flat on a surface.
